(19) United States
(12) Patent Application Publication
(10) Pub. No.: US 2017/0107978 A1
(43) Pub. Date: Apr. 20, 2017

(54) GRAVITATIONAL ENGINE WHICH GENERATES POWER AND ITS PROCESS

(71) Applicant: Raul Milanez, Itapetininga (BR)

(72) Inventor: Raul Milanez, Itapetininga (BR)

(21) Appl. No.: 14/974,669

(22) Filed: Dec. 18, 2015

(30) Foreign Application Priority Data
Oct. 14, 2015 (BR) 1020150260261

(51) Int. Cl. F03G 3/06; F03B 11/06; F03B 13/00; F03B 1/02

(52) U.S. Cl. CPC F03G 3/06; F03B 1/02; F03B 11/06; F03B 13/00

(57) ABSTRACT

A gravitational engine used to generate energy and its respective operation. The main elements to the performance of the equipment are the water, the force of gravity and the pendulum motion. The gravitational motor that generates energy 1 is set basically by a optionally rectangular reservoir 2, which holds a liquid, preferably water; a turbine 3, positioned internally in its higher point; and, a vertical tube 5 connected in the opposite end of the turbine.

The present application for privilege of invention aims to provide a gravitational engine used to generate energy and its respective operation. The main elements to the performance of the equipment are the water, the force of gravity and the pendulum motion.

It is very well known the inefficiency of current energy generation processes. Like the petroleum with their pollution potential and its imminent shortage; the dangerous atomic energy and its threatening waste; the use of the winds which do not always occur where and when they are needed; hydropower, which has a high cost of implementation, restricted use and generally has little or no availability. Besides the high cost, these processes and their sources are not always available.

Such problems do not affect the gravitational force, so if it is transformed into motive power through the invention proposed here, would trigger a series of revolutions in the economic, technological and social sectors in a short time, completely independent of fossil fuels and other sources of polluting.

In the prior art, we can cite Brazilian patent application BR 1020130148792 which depicts a gravitational motor defined by: a reservoir; a directional valve; connecting pipes equipped with valves; container or box divided internally into two chambers; and, transfer pipes fitted with valves.

Although theoretically functional, such motor presented some flaws during tests. The first fault detected demonstrates low pressure during the alternating movement of the water in the transfer pipes, this movement unable to rotate the shaft connected to a generator or alternator. The second problem was related to the air stored in the cameras belonging to the container, because it must assist in the process of transferring the accumulated water in the chambers. Instead, the entrapped air prevents the displacement of water flow from a reservoir to the other, interrupting the gravitational engine cycle

It is also mentioned Brazilian patent application BR 1320140197701 record set by gravitational force capture device consisting of: vertical shaft with upper and lower brackets fitted with rods and bearings; group of lower blades; upper and lower segments fixed, composed of mobile segments that have a pair of locks and propellers group.

Initially, the function of this device was to allow the use of gravitational force produced in the device explained in the Brazilian patent application BR 1020130148792, however, it was noted that their group of lower propellers did not produce a satisfactory rotary motion, making the device unable to comply with the proposed function.

Finally, the Brazilian patent application BR 2020140245834 requires a setting applied in gravitational engine that multiplies energy, formed basically by reservoir, driving pipes, helical of screws conveyors, and shaft equipped with pulley and set of propellers.

After testing Brazilian patent application BR 2020140245834, it was concluded that the turning of the blades, and the BR 1020130148792, was not regular, making inefficient configuration.

In order to address the deficiencies found during tests conducted in previous devices and provide a highly efficient energy generator, was developed an innovative concept in gravitational engine, which will be elucidated in detail following the report.

### BRIEF DESCRIPTION OF THE FIGURES

This inventive activity will be described below in detail, non-limiting example, with reference to its preferred setting illustrated in the drawings below, in which:

FIG. 1, illustrates in perspective the equipment in its preferred arrangement;

FIG. 2, shows in rear view the external components of the gravitational engine;

FIG. 3, exhibit a sectional side of the gravitational engine internal components and operation of the equipment;

FIG. 4, shows in perspective the preferred layout of the turbine utilized;

FIG. 5, depicts the isometric view of a variable configuration of the gravitational engine;

FIG. 6, represents in side view the components and operation of the variable configuration of the gravitational engine.

### DETAILED DESCRIPTION OF THE INVENTION

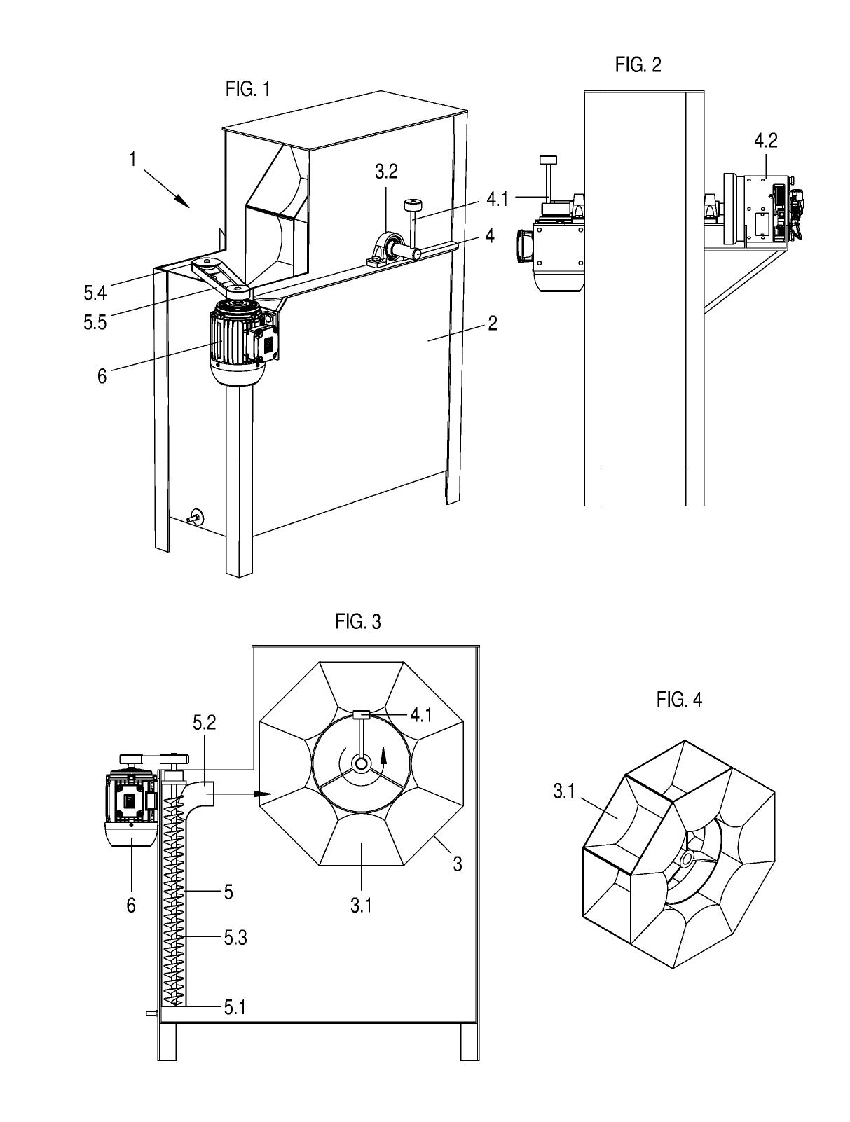

According to FIGS. 1 to 4, the gravitational motor that generates energy 1 is set basically by a optionally rectangular reservoir 2, which holds a liquid, preferably water; a turbine 3, positioned internally in its higher point; and, a vertical tube 5 connected in the opposite end of the turbine.

The turbine 3 is composed by individual compartments 3.1 throughout its diameter and remains coupled in the reservoir 2 by using bearings 3.2, as like the shaft 4, which is equipped with a pendulum 4.1 in one end and, and an electrical generator 4.2 in the opposite end.

Detailing better the vertical tube 5, such object has a lower opening 5.1 for capturing of the liquid, a perpendicular output 5.2 dedicated to the compartments of the turbine and a spindle or helical 5.3 (such as those used in screws conveyors) positioned internally. This spindle is equipped with an upper pulley 5.4, which is connected, through belt 5.5, at a motor 6 in charge of produce its circular movement.

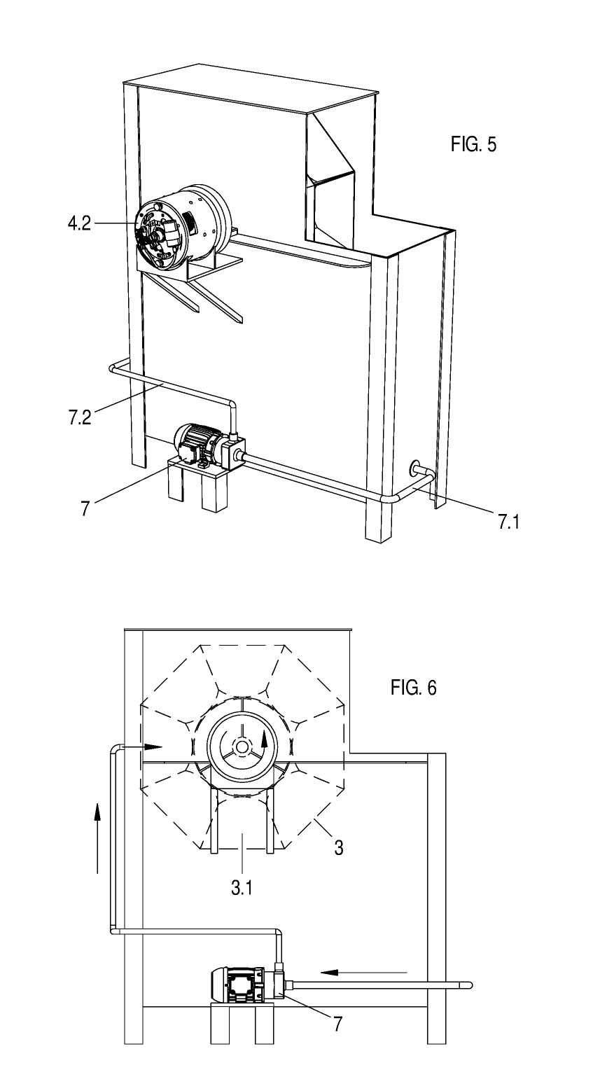

Besides of the elucidated constructive disposition, a second form can be adopted to the gravitational engine FIGS. 5 and 6. This second pattern replaces the tube, the spindle and the motor by a pump 7 and pipes 7.1 and 7.2 installed on the outer lower section of the reservoir. In this model, the water is suctioned by the primary pipe 7.1 and sequentially thrust through secondary pipe 7.2 directly in the individual compartments of the turbine, performing the same process as the first machine.

As is shown in FIGS. 3 and 6, the water accumulated in the container is suctioned by the spindle 5.3 or by the pump 7, and released in the individual compartments 3.1 of the turbine 3 (indicated in arrows), starting its rotation. The pendulum 4.1 (attached to shaft) rotates simultaneously as the turbine rotates and upon completion a rotation the existing weight at the tip of the rod contributes to the increase in turbine speed. All the rotating movement is transmitted directly to the generator 4.2 (best viewed in FIG. 5). The generator 4.2 is responsible for supplying power subsequently to: batteries; power grids; and, even feed the own motor of the equipment, making this self-sustaining.

The main element of the equipment is the pendulum 4.1 positioned on the outer edge of the shaft, which also supports the turbine that essentially revolves around its own axis.

It is known that a weight attached for a rod to a shaft never could complete the 360 degrees around this axis with only the force of gravity, because the inertia would recede the movement before completing a turn, thus making the circular movement limited due to lack of about 18 to 20 degrees every turn. Known this information and whereas the turbine spin would not be completed by itself, was introduced a jet of water or air in the form of impulse, thus maintaining the perpetual motion and increasingly accelerated the turbine up to the limit of the proper functioning of the generator. This fact makes possible the use of gravitational force in applications of clean energy, inexhaustible and of low cost.

It is necessary to adjust the power of the generator and the motor torque, as well as the number of rotations performed, varying according to the size of the equipment and the strength of the materials used.

The advantages of this gravitational engine that multiplies energy, with respect to known models in the prior art, consist in:
Offering a simplified structure mechanically, making it easy to operation and maintenance;
Providing a stable performance, enabling the generation of sustainable energy and constant;
Benefiting the population without any harm to the environment;
High cost-effectiveness.

It is noteworthy that the invention elucidated in this report was understood as representative object and not limited. It may suffer variations and dimensional changes in their way of conduct, if these modifications do not depart from its inventive activity.

What is claimed is:

1. A gravitational engine which generates power and its process, characterized in that the gravitational motor that generates energy 1 has a reservoir 2, which holds water and uses a turbine 3 positioned internally in its higher point and, a vertical tube 5 connected in the opposite end of the turbine.

2. The gravitational engine of claim 1, characterized in that the turbine 3 is composed of individual compartments 3.1 throughout its diameter and remains coupled in the reservoir 2 by using bearings 3.2 alongside the shaft 4, which is equipped with a pendulum 4.1 in one end, and an electrical generator 4.2 in the opposite end.

3. The gravitational engine of claim 1, characterized in that the vertical tube 5 has a lower opening 5.1 for capturing of the liquid, a perpendicular output 5.2 dedicated to the compartments of the turbine and a spindle or helical 5.3 (such as those used in screws conveyors) positioned internally, said spindle is equipped with an upper pulley 5.4 which is linked, through belt 5.5, at a motor 6 in charge of produce its circular movement.

4. The gravitational engine of claim 1, characterized in that the gravitational engine provide a second model that replaces the tube, the spindle and the motor by a pump 7 and pipes, 7.1 and 7.2, installed on the outer lower section of the reservoir.

5. The gravitational engine of claim 1, characterized in that the water accumulated in the container is suctioned by the spindle 5.3 or by the pump 7, and released in the individual compartments 3.1 of the turbine 3, starting its rotation and consequently that of the pendulum 4.1 attached to shaft, contributing to the increase in turbine speed, lastly the rotating movement is transmitted to the generator 4.2
